(19) United States
(12) Patent Application Publication
(10) Pub. No.: US 2010/0279242 A1
(43) Pub. Date: Nov. 4, 2010

(54) APPARATUS FOR PREHEATING BATCHES OF GLASS CULLET

(75) Inventors: Hansjürgen Barklage, Nienburg (DE); Wolfgang Cieleback, Nienburg (DE); Rolf Schaper, Wahlstedt (DE)

Correspondence Address: SMITH, GAMBRELL & RUSSELL, SUITE 3100, PROMENADE II, 1230 PEACHTREE STREET, N.E., ATLANTA, GA, 30309-3592, US

(73) Assignee: Ardagh Glass GmbH, Nienburg (DE)

(21) Appl. No.: 12/772,328

(22) Filed: May 3, 2010

(30) Foreign Application Priority Data
May 4, 2009 (DE) 10 2009 019 456.8

(51) Int. Cl. F27D 3/00

(52) U.S. Cl. 432/239

(57) ABSTRACT

An apparatus for preheating a batch (12) of glass cullet which is preferably enriched with raw materials for glass production, comprising a bunker (14) and flow ducts (22) formed therein, wherein the bunker (14) comprises a plurality of flow ducts (22) which are arranged vertically, and if appropriate offset, one above another and extend at an angle in relation to the vertical, in particular horizontally, wherein each flow duct (22) is composed of a profiled section (34) for forming an upper half thereof and also a heap of the batch (12) of glass cullet which is formed underneath the profiled section and forms the lower half of the flow duct (22), and wherein the profiled section has at least two limbs (36a, b) which laterally delimit the space between them. To reduce the flow rate in the flow ducts (22), at least one limb (36a, b) of the profiled section (34), preferably both limbs, has at least one convexly curved region (46) and/or a first uncurved region (40) which has a first angle of inclination in relation to the horizontal and is adjoined by an uncurved second region (42) with a different angle of inclination, and/or in that, in order to reduce the flow rate in the flow ducts (22), at least two (22a, b, c) of the flow ducts (22) which are arranged directly, and if appropriate offset, one above another are connected to a common feed line (26a) in the sense of a parallel connection with respect to the direction of flow.

### STATEMENT OF RELATED APPLICATIONS

This application is based on and claims the benefit of German Patent Application No. 10 2009 019 456.8 having a filing date of 4 May 2009, which is incorporated herein in its entirety by this reference.

### BACKGROUND OF THE INVENTION

1. Technical Field

The invention relates to an apparatus for preheating a batch of glass cullet which is preferably enriched with raw materials for glass production, comprising a bunker and flow ducts formed therein, wherein the bunker comprises a plurality of flow ducts which are arranged—if appropriate offset—one above another and extend at an angle in relation to the vertical, in particular horizontally, wherein each flow duct is composed of a profiled section for forming an upper half thereof and also a heap of the batch of glass cullet which is formed underneath the profiled section and forms the lower half of the flow duct, and wherein the profiled section has at least two limbs which laterally delimit the space between them.

2. Prior Art

An apparatus of this type is known, for example, from German Patent No. DE 34 16 317 C2. During the glass production process, this apparatus serves to utilize the thermal energy of the offgases produced during the combustion of the raw materials in the melting furnace for preheating the batch of glass cullet. For this purpose, the offgases are guided along the flow ducts through the bunker, specifically through the batch of glass cullet—if appropriate in that they have preheated the combustion air required for the melting operation beforehand after they have passed through a heat exchanger. Within the bunker, at least some of the thermal energy of the offgas is transferred to the batch of glass cullet. The preheating of the batch of glass cullet ultimately reduces the amount of thermal energy needed for the melting operation in the melting furnace.

However, the offgases guided through the flow ducts of the bunker are disadvantageously contaminated by substances adhering to the glass cullet.

For reasons of emission control, the cold offgases have to be purified after the batch of glass cullet has been preheated, before they can be emitted to the ambient air. In this context, both the harmful substances originating from the batches of glass cullet and harmful substances intrinsic to the offgas anyway are filtered out.

In this context, it is known from German Patent No. DE 34 16 317 C2 to do this by conducting the cold offgases through a so-called wet scrubber, in which they are rinsed with a washing fluid. Here, solids are precipitated from the offgas and gaseous harmful substances are condensed.

It is also known to connect an electrofilter downstream of the wet scrubber. In order to bring the harmful gas components SO_{X}, HCl and HF in the offgas to sufficiently low concentrations so as to comply with emission regulations, it has been necessary to date to add additives which led to improved precipitation of said harmful gas components in the electrofilter to the offgas.

### BRIEF SUMMARY OF THE INVENTION

Proceeding from this prior art, it is an object of the present invention to specify a preheating apparatus of the type mentioned in the introduction, by means of which it is possible, as compared with the prior art, to reduce the concentration of at least one harmful substance in the offgas after it has passed through the apparatus.

This object is achieved by a preheating apparatus for preheating a batch of glass cullet which is preferably enriched with raw materials for glass production, comprising a bunker and flow ducts formed therein, wherein the bunker comprises a plurality of flow ducts which are arranged vertically—if appropriate offset—one above another and extend at an angle in relation to the vertical, in particular horizontally, wherein each flow duct is composed of a profiled section for forming an upper half thereof and also a heap of the batch of glass cullet which is formed underneath the profiled section and forms the lower half of the flow duct, and wherein the profiled section has at least two limbs which laterally delimit the space between them, characterized in that, in order to reduce the flow rate in the flow ducts, at least one limb of the profiled section, preferably both limbs, has at least one convexly curved region and/or a first uncurved region which has a first angle of inclination in relation to the horizontal and is adjoined by an uncurved second region with a different angle of inclination, and/or in that, in order to reduce the flow rate in the flow ducts, at least two of the flow ducts which are arranged directly—if appropriate offset—one above another are connected to a common feed line in the sense of a parallel connection with respect to the direction of flow.

According to the invention, it has been recognized that a reduction in the flow rate of the offgas as it passes through the bunker of the preheating apparatus has two effects: firstly, a reduction in the flow rate means that the offgas has a lower dust content picked up from the batch of glass cullet after it has passed through. Similarly, the concentration of other harmful gas components in the offgas, in particular SOₓ, HCl and/or HF, is reduced.

The results are achieved because the offgas can react with the batch of glass cullet flowing past for a considerably longer period of time compared to the prior art. The result of the reduction in flow rate according to the invention is positive to such an extent that it is now even possible to dispense with the addition of additives for increasing the efficiency of the electrofilter, which may be provided downstream. Depending on the overall design of the preheating apparatus, it appears to be conceivable to even dispense with downstream filter systems completely.

According to the first embodiment according to the invention, the reduction in flow rate is achieved in that the flow cross section of the flow ducts is changed, in particular increased, with respect to the flow cross sections known from the prior art.

For this purpose, the profiled section which delimits the flow duct in each case at the top can have at least one limb having a convexly, i.e. outwardly, curved region. Because the profiled sections are convexly curved at least in regions, the space enclosed between these profiled sections or the space delimited by them is particularly large. Therefore, the flow cross section of the flow duct formed at the top by the profiled section and at the bottom by the heap of the batch of glass cullet is also particularly large.

As a rule, each profiled section according to the invention generally has an upper apex line which extends horizontally or—if the profiled section extends correspondingly in the bunker—at an angle in relation to the horizontal, the profiled section having two, preferably identical, limbs which extend downwards at an angle in relation to the horizontal at least in regions on both sides of the apex line. The profiled section is preferably symmetrical in relation to a centre plane.

In terms of the regions of convex curvature, both limbs of the profiled section therefore preferably have such regions.

In one particular embodiment of the invention, these regions of convex curvature each directly adjoin the apex line of the profiled section. This can take place in different ways.

By way of example, the profiled section can be formed in such a way that the tangent which describes the convex curvature of one limb at an apex of the profiled section located on the apex line, and the tangent which describes the convex curvature of the other limb at the same apex, extend at an angle in relation to one another. This generally means that the apex line is an upper bend line or edge of the profiled section.

Alternatively, the profiled section can be formed in such a way that the tangent which describes the convex curvature of one limb at an apex of the profiled section located on the apex line, and the tangent which describes the convex curvature of the other limb at the same apex, are identical or lie one above another. By way of example, the profiled section then has an overall semicircular or arc-like shape in the upper region, without a bend line or bend edge being formed.

According to a further embodiment of the profiled section according to the invention, one or each profiled section limb has in each case a first uncurved region having a first angle of inclination in relation to the horizontal when arranged in the bunker, and a second uncurved region which adjoins the first uncurved region and has a second angle of inclination, which differs from the first angle of inclination of the first uncurved region. In this case, the angle of inclination of the first uncurved region in relation to the horizontal is preferably smaller than that of the second uncurved region. By way of example, the first uncurved region can thus be guided downwards at an inclination of between 20-35° in relation to the horizontal. This can then be adjoined by the second uncurved region with an angle of inclination of between 70°-90°. However, the second uncurved region particularly preferably extends downwards directly (substantially) perpendicularly in relation to the horizontal, i.e. 90° in relation to the horizontal. As a rule, the first uncurved region of the respective limb directly adjoins the apex line in each case.

In addition or as an alternative to the reduction in flow rate as a result of a suitable design of the profiled sections, the flow rate can be reduced, according to the invention, by the following measure:

At least two, preferably at least three of the flow ducts, which are in direct succession, in particular, and are arranged one above another, are connected to a common feed line or to a common feed duct in the sense of a parallel connection with respect to the direction of flow. In this case, the flow ducts connected in parallel are preferably the at least two, preferably the at least three topmost flow ducts of the bunker. Compared to the prior art, the flow rate in these flow ducts connected in parallel is therefore effectively reduced.

In terms of the common feed line, this extends within the bunker preferably at least approximately vertically, generally speaking in any case at an angle in relation to the horizontal.

Expediently, the common feed line connects the flow ducts connected in parallel to one another at the opposing ends thereof and to the opposing end of a further flow duct arranged underneath the flow ducts connected in parallel.

### BRIEF DESCRIPTION OF THE DRAWINGS

Further features of the present invention are apparent from the accompanying patent claims, from the following description of preferred exemplary embodiments of the invention and from the accompanying drawings, in which:

FIG. 1 shows an oblique view, partially cut away, of an apparatus according to the invention for preheating a batch of glass cullet, and

FIGS. 2a-2d show cross sections of profiled sections of different flow duct profiled sections which can be used according to the invention in the preheating apparatus.

### DETAILED DESCRIPTION OF PREFERRED EMBODIMENTS

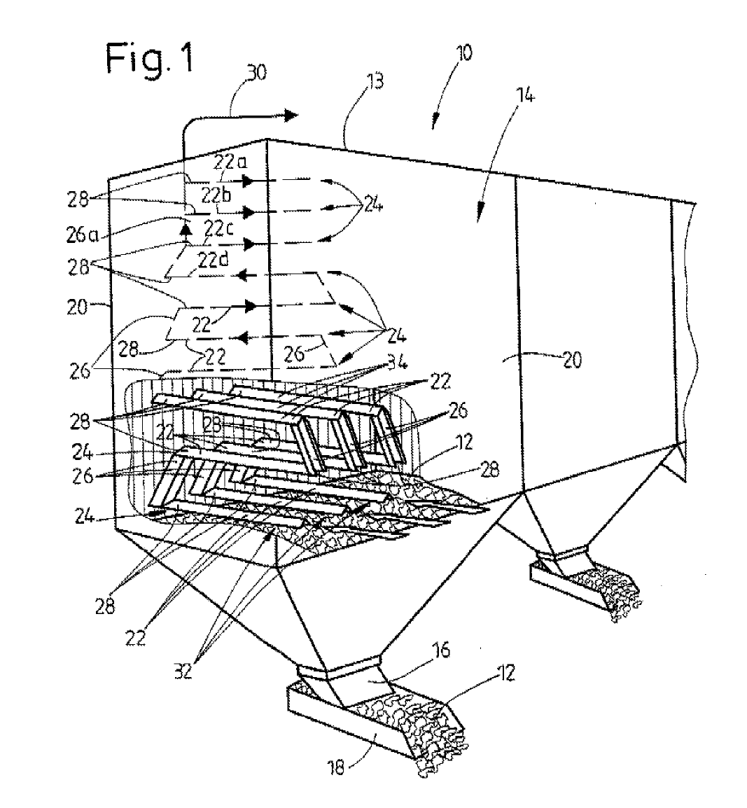

FIG. 1 shows an apparatus 10 according to the invention for preheating a batch 12 of glass cullet, comprising a bunker 14.

The batch 12 of glass cullet is fed continuously or batchwise to the bunker 14 through an upper opening 13. At the end, the batch 12 of glass cullet can be removed from a lower, funnel-shaped outlet 16. It is then conveyed on using a vibrating conveyor 18 or another conveyor. In this way, glass cullet generally flows approximately continuously from top to bottom in the bunker 14 at least when the batch 12 of glass cullet is fed in continuously. In a manner explained in greater detail below, the batch 12 of glass cullet is heated as it passes through the bunker 14.

After the batch 12 of glass cullet has been removed from the vibrating conveyor 18, the preheated batch 12 of glass cullet is finally fed, in a manner known per se, to a melting end (not shown) of a glass melting furnace (likewise not shown), in which the actual melting operation takes place.

In order to preheat the batch 12 of glass cullet in the bunker 14, hot offgases which arise during the melting operation in the glass melting furnace are fed to the bunker 14. A large number of horizontally extending flow ducts 22 are located within the main part of the bunker 14, which, in the present case, has a square cross section and is formed by upright side walls 20. In the present case, there are effectively ten duct planes 24 arranged in each case one above another within the main part of the bunker 14. In each case three flow ducts 22 are arranged alongside one another in one horizontal plane per duct plane 24. In addition, the flow ducts 22 of the individual, successive duct planes 24 are arranged offset in relation to one another, to be precise in each case roughly by half the distance between two adjacent flow ducts 22 in one duct plane. The individual flow ducts 22 are thus distributed approximately uniformly inside the bunker 14 “in a staggered fashion”.

The offgases of the glass melting furnace are fed to the flow ducts 22 of the bottommost duct plane 24 of the bunker 14 at an end 28 by means of offgas connection lines (not shown) in the direction of the arrow. The flow ducts 22 of the bottom seven duct planes 24 are connected at their respective opposing ends 28 from one plane 24 to the other by connection lines 26, specifically by overflow ducts 26. These bottom seven flow ducts 22 are therefore connected in series with respect to the direction in which the offgas flows. By contrast, the three topmost flow ducts 22 are connected in parallel with respect to the direction in which the offgas flows, and this will be explained in more detail below.

As the batch 12 of glass cullet is being preheated, the hot offgases flow through the flow ducts 22 level by level and the overflow ducts 26 from bottom to top. With respect to the flow of the batch 12 of glass cullet from top to bottom, the offgases are therefore guided through the batch 12 of glass cullet in crosswise countercurrent.

On its flow path, the offgas emits the thermal energy stored in it for the most part to the batch 12 of glass cullet which flows past, and heats the latter. The offgas which is then largely cooled, or the offgas which is cooler with respect to the temperature at which it enters the lower region of the bunker, is finally guided out of the upper part of the bunker 14 by means of offgas discharge lines 30. FIG. 1 shows only one of the discharge lines 30. However, in the present exemplary embodiment three separate, vertical offgas circuits 32 are formed alongside one another in the horizontal direction, specifically by the flow ducts 22 arranged in each case alongside one another in a duct plane 24 or the adjacent overflow ducts 26. Accordingly, there is initially one dedicated discharge line 30 for each vertical offgas circuit 32. However, the three discharge lines 30 may be joined together at a later stage.

In the present case, each flow duct 22 has approximately the same design. In the embodiment shown in FIG. 1, it has an upper half, specifically an elongate profiled section 34, in this case an angled profiled section 34 having two identical limbs 36a, 36b. Here, the profiled sections 34 of the flow ducts 22 within the bunker 14 are arranged in such a manner that the two limbs 36a, 36b thereof point obliquely downwards at approximately an identical angle, specifically at an angle of about 45° in relation to the horizontal.

The profiled sections 34 shown in FIG. 1 each have an upper apex line 38, in this case a pronounced apex edge 38, proceeding from which the two limbs 36a, 36b extend obliquely downwards.

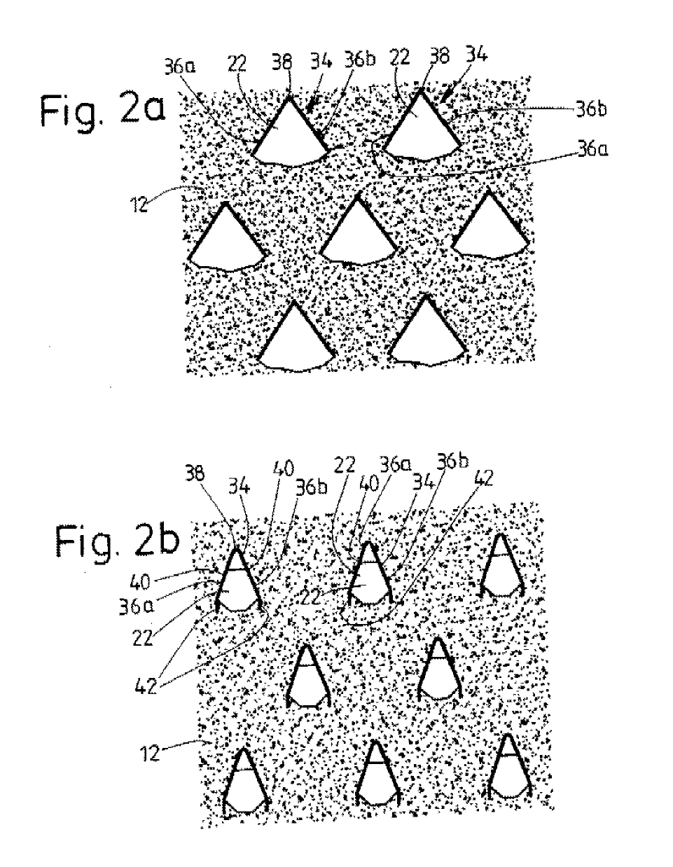

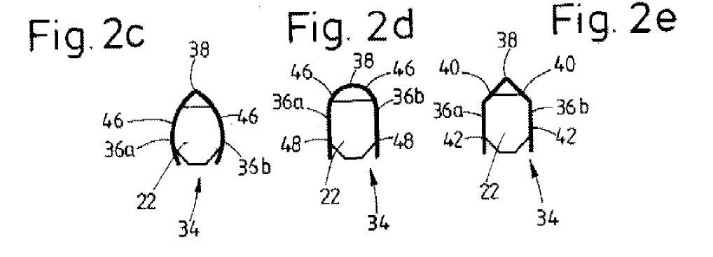

The profiled sections 34 each form a roof for the batch 12 of glass cullet which flows from top to bottom. As a result, a heap is formed underneath the profiled section 34 in each case in the batch 12 of glass cullet, and this heap forms the second half of the flow ducts 22. In other words, the boundary surface of each flow duct 22 to the lower half is formed directly by the batch 12 of glass cullet. The formation of the profiled sections 34 shown in FIG. 1 and of the flow duct 22 thereby produced can readily be seen in cross section in FIG. 2a.

As it flows through the bunker 14, the offgas comes into contact or interacts with the batch of glass cullet. Particularly in the lower region of the bunker 14, the offgas picks up dust from the batch of glass cullet. In order to comply with emission regulations, this pick-up of dust has to be kept to a minimum. In addition, harmful substances present in the offgas have to be filtered out of the offgas.

This takes place by means of filter devices (not shown), such as a wet scrubber and/or a downstream electrofilter, which are used after the offgas has flowed through the bunker 14.

In a particular way, according to the invention, the offgas guided out of the bunker 14 by the offgas discharge lines has an especially low dust content and especially low concentrations of other harmful substances.

For this purpose—as already indicated further above—according to a first measure the three topmost flow ducts 22a, b, c are connected in parallel in each vertical offgas circuit 32. In other words, the three topmost flow ducts 22a, b, c are connected to a common offgas feed line 26a, specifically to the common overflow duct 26a, in the sense of a parallel connection. For this purpose, the four topmost flow ducts 22a, b, c, d are connected to one another at their opposing ends 28 by means of the corresponding overflow duct 26a.

This parallel connection of the three topmost flow ducts 22a, b, c considerably reduces the flow rate of the offgas in these flow ducts 22a, b, c. It has surprisingly been found that, as a result of this reduction in the flow rate, dust that the offgas picks up from the batch of glass cullet in the lower region of relatively high flow rate is discharged back to the batch 12 of glass cullet in this upper region of reduced flow rate.

It has also been found that the offgas also interacts with the batch of glass cullet in another way as a result of said reduction in flow rate, specifically by various other harmful gas components being precipitated or transferred to the batch 12 of glass cullet. The more detailed chemical processes are currently still being investigated. As a result, the reduction in the flow rate considerably reduces the concentration of harmful gas in the offgas. This applies, in particular, to the harmful gas components SO_{X}, HF and HCl.

Before the invention, it was necessary to add additives to the offgas as it was being subjected to a filtering operation, which follows the glass batch preheating, by means of an electrofilter, in order to increase the efficiency of the electrofiltering such that the purified offgas was harmless in terms of emission. Owing to the measure, according to the invention, of flow rate reduction, this is advantageously no longer absolutely necessary. Overall, the electrofilter connected downstream is not required for long periods of time.

A further reduction in the flow rate, as compared with the prior art, is achieved by means of a different cross-sectional form of the flow ducts 22.

The angled profiled sections 34 shown in FIG. 2a are known in principle from the prior art. According to the invention, novel profiled sections 34 which ultimately lead to different, in particular larger, flow cross sections are used.

FIG. 2b shows profiled sections 34 in which the two limbs 36a, 36b each have a first uncurved portion or region 40 and an adjoining, second uncurved region 42. The first uncurved region 40 is at a smaller angle with respect to the horizontal, in the present case about 70°, than the second uncurved region 42, which in the present case extends at an angle of 90° in relation to the horizontal. The profiled section 34 is symmetrical with two respectively identical limbs 36a, 36b. As is also shown, the first uncurved regions 40 of the two limbs 36a, 36b do not taper towards one another to form a bend edge or bend line 38. Instead, they form a curved or cambered connection region 44 having an upper (imaginary) apex line 38 which extends horizontally perpendicular to the plane of the drawing.

FIG. 2c shows a further advantageous profiled section form. Here, each limb 36a, 36b has a region 46 of outward convex curvature, without adjoining uncurved regions. In their upper connection region, the limbs 36a, 36b extend at an angle so as to form an apex line 38 which is in the form of a pronounced bend line or bend edge 38. In other words, the profiled section 34 shown in FIG. 2c is formed in such a way that the tangent which describes the convex curvature 46 of the limb 36a at an apex of the profiled section 34 located on the bend line 38 or apex line 38, and the tangent which describes the convex curvature of the other limb 36b at the same apex, extend at an angle in relation to one another and intersect one another, in particular at the apex.

In contrast thereto, in the case of the profiled section 34 in the further embodiment shown in FIG. 2d, the tangent which describes the convex curvature 46 of the limb 36a at an apex of the profiled section 34 located on the apex line 38, and the tangent which describes the convex curvature of the limb 36b at the same apex, lie one above another or are identical. By way of example, the profiled section 34 then has an overall semicircular or arc-like shape in the upper region, without a bend line or bend edge being formed. Proceeding from the apex line 38, each limb 36a, 36b has a first region with convex curvature 46 which is adjoined by a second, vertically extending uncurved region 48. The convex curvatures 46 of the two respective limbs 36a, 36b are identical.

FIG. 2e shows a further embodiment of the profiled section 34. In systematic terms, this embodiment corresponds to the embodiment shown in FIG. 2b. Unlike in the embodiment shown in FIG. 2b, however, here the first uncurved region 40 is shorter than the second uncurved region 42. In addition, the angle of the first uncurved region 40 in relation to the horizontal is smaller than that of the profiled section 34 shown in FIG. 2b. Here, it is about 45°.

It is vital that the respective profiled sections 34 are formed in such a way that the largest possible cross-sectional surface area of the flow duct 22 is obtained.

### LIST OF REFERENCE SYMBOLS

10 Preheating apparatus
12 Batch of glass cullet
13 Upper opening
14 Bunker
16 Outlet
18 Vibrating conveyor
20 Side wall
22 Flow duct
22a-22d Flow duct
24 Duct plane
26 Connection line
26a Connection line
28 End
30 Discharge line
32 Offgas circuit
34 Profiled section
36a Limb
36b Limb
38 Apex line
40 Uncurved region
42 Uncurved region
44 Connection region
46 Curved region
48 Uncurved region

What is claimed is:

1. An apparatus for preheating a batch (12) of glass cullet which is preferably enriched with raw materials for glass production, comprising a bunker (14) and flow ducts (22) formed therein, wherein:
the bunker (14) comprises a plurality of the flow ducts (22) which are arranged vertically one above another and extend at an angle in relation to the vertical,
each of the flow ducts (22) is composed of a profiled section (34) for forming an upper half thereof and also a heap of the batch (12) of glass cullet which is formed underneath the profiled section and forms the lower half of the flow duct (22),
the profiled section has at least two limbs (36a, b) which laterally delimit the space between them, and
in order to reduce the flow rate in the flow ducts (22), at least one of the limbs (36a, b) of the profiled section (34) has at least one convexly curved region (46) and/or a first uncurved region (40) which has a first angle of inclination in relation to the horizontal and is adjoined by an uncurved second region (42) with a different second angle of inclination, and/or in that, in order to reduce the flow rate in the flow ducts (22), at least two (22a, b, c) of the flow ducts (22) which are arranged directly one above another are connected to a common feed line (26a) in the sense of a parallel connection with respect to the direction of flow.

2. The apparatus according to claim 1, wherein at least the two topmost flow ducts (22a, b, c) of the bunker (14) are connected to the common feed line (26a).

3. The apparatus according to claim 1, wherein the common feed line (26a) extends at least approximately vertically.

4. The apparatus according to claim 1, wherein in each case two flow ducts (22) arranged directly one above another are connected to one another by connection lines (26) which are arranged on the opposing ends of said flow ducts and extend at least in sections at least approximately vertically.

5. The apparatus according to claim 1, wherein the two limbs (36a, b), proceeding from an upper apex line (38) of the profiled section (34), extend downwards at an angle in relation to the horizontal at least in regions on both sides of the apex line (38).

6. The apparatus according to claim 5, wherein both limbs (36a, b) have the regions of convex curvature (46), these regions (46) each directly adjoining the upper apex line (38) of the profiled section (34) or being connected to one another at that point.

7. The apparatus according to claim 6, wherein the profiled section (34) is formed in such a way that a tangent that describes the convex curvature (46) of one limb (36a) at an apex of the profiled section (34) located on the apex line (38), and a tangent that describes the convex curvature (46) of the other limb (36b) at the same apex, extend at an angle in relation to one another.

8. The apparatus according to claim 6, wherein the profiled section (34) is formed in such a way that a tangent that describes the convex curvature (46) of one limb (36a) at an apex of the profiled section (34) located on the apex line (38), and a tangent that describes the convex curvature (46) of the other limb (36b) at the same apex, are identical or lie one above another.

9. The apparatus according to claim 6, wherein an uncurved, vertically extending region (48) of the profiled section (34) adjoins the respective region of convex curvature (46).

10. The apparatus according to claim 5, wherein both of the limbs (36a, b) have the uncurved regions (40, 42) with the first or second angle of inclination, the region (40) with the first angle of inclination directly adjoining the apex line (38) in each case.

11. The apparatus according to claim 5, wherein the first angle of inclination is smaller than the second angle of inclination.

12. The apparatus according to claim 1, wherein the second angle of inclination is approximately 90° in relation to the horizontal.

13. The apparatus according to claim 1, wherein the flow ducts (22) are arranged offset from one another.

14. The apparatus according to claim 1, wherein the flow ducts (22) extend at a horizontal angle in relation to the vertical.

15. The apparatus according to claim 1, wherein, both of the limbs (36a, b) have at least one convexly curved region (46) and/or a first uncurved region (40).

16. The apparatus according to claim 1, wherein the three topmost flow ducts (22a, b, c) of the bunker (14) are connected to the common feed line (26a).

17. The apparatus according to claim 2, wherein the flow ducts (22) are connected to the common feed line (26a) by opposing ends (28) of the flow ducts (22a, b, c) being connected to the feed line (26a).

18. The apparatus according to claim 16, wherein the flow ducts (22) are connected to the common feed line (26a) by opposing ends (28) of the flow ducts (22a, b, c) being connected to the feed line (26a).

19. The apparatus as claimed in claim 5, wherein the apex line (38) extends horizontally.

20. The apparatus according to claim 7, wherein an uncurved, vertically extending region (48) of the profiled section (34) adjoins the respective region of convex curvature (46).

21. The apparatus according to claim 8, wherein an uncurved, vertically extending region (48) of the profiled section (34) adjoins the respective region of convex curvature (46).
